(19) United States
(12) Patent Application Publication
(10) Pub. No.: US 2011/0143673 A1
(43) Pub. Date: Jun. 16, 2011

(54) AUTOMATIC POSITIONING OF DIVERSITY ANTENNA ARRAY

(75) Inventors: Lior Landesman, Cupertino, CA (US); Erez Marom, Cupertino, CA (US)

(73) Assignee: Direct-Beam Inc., Cupertino, CA (US)

(21) Appl. No.: 12/968,710

(22) Filed: Dec. 15, 2010

Related U.S. Application Data
(63) Continuation-in-part of application No. 12/474,584, filed on May 29, 2009.
(60) Provisional application No. 61/335,284, filed on Jan. 4, 2010.
(60) Provisional application No. 61/188,129, filed on Aug. 6, 2008.
(60) Provisional application No. 61/191,464, filed on Sep. 9, 2008.
(60) Provisional application No. 61/209,193, filed on Mar. 4, 2009.

(51) Int. Cl. H04B 15/00

(52) U.S. Cl. 455/63.1

(57) ABSTRACT

Embodiments of the invention provide an antenna system for connecting to a wireless device through a communication link. The antenna system comprising an antenna array configured to pre-scan frequency bands of radio signals in a plurality of antenna array directions, a transceiver connected to the antenna array. The transceiver is configured to analyze the signals received from the antenna array to obtain one or more parameters from one or more MIMO channels of the antenna array, and transmit the one or more parameters to the antenna controller. Further, the antenna system comprises a platform connected to the antenna array, wherein the platform is configured to position the antenna array, and a motor controller connected to the platform. The motor controller is configured to receive one or more position signals from the device, wherein the position signals correspond to a pre-scanned performance level of the communication link based on the parameters, and control the position of the antenna array by rotating the platform based on the position signals.

### CROSS-REFERENCE OF RELATED APPLICATION

This application claims priority of co-pending U.S. Provisional Patent Application 61/335,284, and U.S. Non-Provisional patent application Ser. No. 12/474,584, which claims priority to U.S. Provisional Application Nos. 61/188,129, 61/191,464, and 61/209,193,contents of all of these applications are incorporated by reference.

### FIELD OF THE INVENTION

Embodiments of the invention generally relates to diversity antenna array, and more specifically to antenna arrays and methods for automatic positioning of the antenna array.

### BACKGROUND

Modern wireless technologies face the challenges of signal fading, multi-path, and increasing interferences that result in decreased reliability, range and data throughput. Directional antennas and antenna diversity (antenna array) may be used to mitigate the effects of fading, multi-path and for reducing undesired interferences. The wireless technologies utilize MIMO (Multi Input Multi Output) systems. The MIMO systems demonstrate optimum performance with Omni-directional antennas such as dipoles, monopoles or inverted-F elements. Typically, this conception is based on the assumption that the multi-path fading in indoor and outdoor environments is purely random that is no preference is given to any specific direction. Therefore, it may desired not to limit the effective angular spread of the radiation and thus to transmit and receive the signals isotropically.

However, generally the local interferences in indoor scenarios are not statistically “flat” or the scattering of the signals is not isotropic. Therefore, one or more directional antennas can improve the link performance. The link performance may include Signal to Noise Ratio (SNR), Bit Error Rate (BER), capacity, diversity gain, range and so forth. Further, directive antennas with narrow beam-widths and high passive gains in MIMO systems can improve the capacity of the link by factor of two or more. However, the improvement in the link performance due to the directional antennas narrow beam-widths depends on the scattering environment and the performance is sensitive to the location and the position of the antennas. Therefore, a key factor in the performance may the ability to move or rotate the antennas in small steps and adjust them automatically to avoid any scattering situation.

Positioning of directional antenna arrays in a different scattering environment, different networks (each with unique Identification (ID)), and different base stations location (each cover certain physical area) may difficult to be done manually. Automatic systems can position the directional arrays to an appropriate position (azimuth and/or elevation and/or polarization) for improving link performance. However, these automatic systems may not position the antenna arrays based on pre-acquired parameters of specific MIMO channels.

In the light of the above discussion, techniques are desirable for automatic positioning of diversity antenna array.

### SUMMARY

An embodiment of the present invention may provide an antenna system for connecting to one client device through a data interface. The antenna system comprising: an antenna array configured to pre-scan one or more frequency bands of radio signals; a transceiver connected to the antenna array, wherein the transceiver is configured to: analyze the signals received from the antenna array to obtain one or more parameters from one or more MIMO channels; and transmit the one or more parameters to the client device; a platform connected to the antenna array, wherein the platform is configured to position the antenna array; and a motor controller connected to the platform, wherein the motor controller is configured to: receive one or more position signals from the client device, wherein the position signals correspond to a pre-scanned performance level of the communication link based on the parameters; and control the position of the antenna array by rotating the platform based on the position signals.

An embodiment of the present invention may provide a wireless device. The wireless device comprising: an antenna controller configured to analyze one or more parameters of radio signals, wherein the antenna controller selects a pre-scanned performance level based on the one or more parameters from one or more MIMO channels; an antenna array configured to pre-scan one or more frequency bands of radio signals; a transceiver connected to the antenna array, wherein the transceiver is configured to: analyze the signals received from the antenna array for one or more parameters; and transmit the one or more parameters to the antenna controller; a platform connected to the antenna array, wherein the platform is configured to position the antenna array; and a motor controller connected to the platform, wherein the motor controller is configured to: receive one or more position signals from the antenna controller, wherein the position signals correspond to a pre-scanned performance level of the communication link based on the parameters; and control the position of the antenna array by rotating the platform based on the position signals.

An embodiment of the present invention may provide a method for positioning an antenna array to be connected to at least one wireless device through a wireless communication link, comprising: pre-scanning for one or more radio signals from one or more MIMO channels by an antenna array; analyzing, by a transceiver, the signals received from the antenna array for one or more parameters; transmitting, by the transceiver, the one or more parameters to the antenna controller; receiving, by the motor controller, one or more position signals from the antenna controller for controlling the position of the antenna array, wherein the position of the antenna array correspond to a pre-scanned performance level of the wireless communication link; and positioning the antenna array by the motor controller based on the position signals.

### BRIEF DESCRIPTION OF THE DRAWINGS:

Having thus described the invention in general terms, reference will now be made to the accompanying drawings, which are not necessarily drawn to scale, and wherein:

FIG. 1 illustrates an environment where various embodiments of the invention function;

FIG. 2A and 2B illustrate exemplary beams from Multiple Input Multiple Output (MIMO) antennas in a wireless device;

FIG. 3A illustrates a block diagram of an antenna system externally connected to a client device in accordance with an embodiment of the invention;

FIG. 3B illustrates a block diagram of an antenna system embedded in the wireless device, in accordance with an embodiment of the invention;

FIG. 3C illustrates exemplary antenna system implemented as a dongle, in accordance with an embodiment of the invention;

FIGS. 4A and 4B illustrate exemplary arrangements of an antenna array, in accordance with an embodiment of the invention;

FIG. 5 illustrates arrangement of multiple directional antennas, in accordance with an embodiment of the invention;

FIG. 6 illustrates an exemplary switched antenna system, in accordance with an embodiment of the invention;

FIG. 7 illustrates an antenna array comprising two back to back antennas, in accordance with an embodiment of the invention;

FIG. 8 illustrates an exemplary table that may be generated during pre-scanning and steering of the antenna array, in accordance with an embodiment of the invention;

FIG. 9 illustrates a flow diagram for controlling the antenna system, in accordance with an embodiment of the invention;

FIG. 10 is a flowchart illustrating scanning in One Dimension, in accordance with an embodiment of the invention;

FIG. 11 is a flowchart illustrating linear scanning in two dimensions, in accordance with an embodiment of the invention;

FIG. 12 is a flowchart illustrating spiral scanning in two dimensions, in accordance with an embodiment of the invention;

FIG. 13 illustrates a state machine diagram corresponding to an algorithm performed at an antenna controller, in accordance with an embodiment of the invention; and

FIG. 14 illustrates a block diagram for connecting an antenna system to a wireless device that may not have a Radio Frequency connector, in accordance with an embodiment of the invention.

### DETAILED DESCRIPTION OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout. Unless otherwise noted in this specification or in the claims, all of the terms used in the specification and the claims will have the meanings normally ascribed to these terms by workers in the art.

Some embodiments of the present invention may provide techniques for automatically positioning diversity antenna array by evaluating the performance of a Radio Frequency (RF) link. The parameters related to RF link are collected by pre-scanning a spectrum by the antenna array. Further, performance levels are collected based on the parameters collected through the pre-scanning. Subsequently, the antenna array may be positioned to achieve a pre-scanned performance level of the RF link.

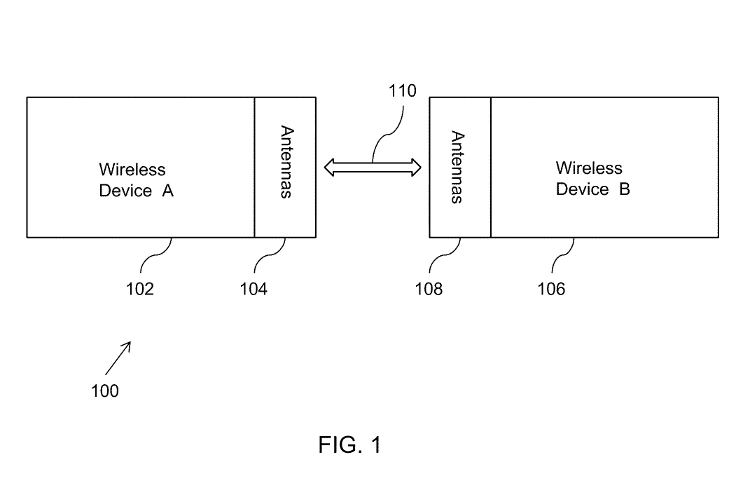

FIG. 1 illustrates an environment 100 where various embodiments of the invention function. Environment 100 includes a wireless device A 102 at a first end and a wireless device B 106 at a second end, and communication through a communication link 110. In an embodiment of the invention, communication link 110 includes a Radio Frequency (RF) communication link. Communication link 110 is hereafter referred to as RF link 110. Wireless device A 102 and wireless device B 106 may implement a Multiple Input Multiple Output (MIMO) system. Examples of wireless device A 102 include, but are not limited to, an Access Point (AP), a wireless router, a Base Station (BS) such as cellular, WiMax, Long Term Evolution (LTE), and so forth. Wireless device A 102 can include multiple antennas 104 that receive and/or transmit RF signals to create RF link 110 with wireless device B 106. Examples of wireless device B 106 include, but are not limited to, a computer, a laptop, a Personal Desktop Assistant (PDA), a mobile phone, a game, a television or any other client computing device. Although a single device B 106 is shown, a person skilled in the art will appreciate that multiple wireless device B 106 can communicate with wireless device A 102.

In an embodiment of the invention, antennas 108 at wireless device B 106 include directive antenna array. Antennas 108 may be positioned toward antennas 104 for generating RF link 110. Further, RF link 110 may include multiple paths that provide substantial improvement in the efficiency of MIMO spatial multiplexing algorithm. Further, the antennas 108 may be automatically positioned including horizontal, vertical and/or polarization by evaluating the performance of RF link 110. In another embodiment of the invention, antennas 104 at wireless device A 102 include directive antenna array. In this case, antennas 104 may be automatically positioned to achieve a pre-scanned performance level of RF link 110. Therefore, a person skilled in the art will appreciate that functionality of wireless device A 102 and wireless device B 106 can be interchanged without changing the scope of the present invention. Further, wireless device A 102 and wireless device B 106 are hereinafter interchangeably referred to as wireless device 114.

Some embodiments of the present invention may provide systems and methods for collecting the performance level of RF link 110 and automatically positioning diversity antennas arrays by evaluating the performance of RF link 110.

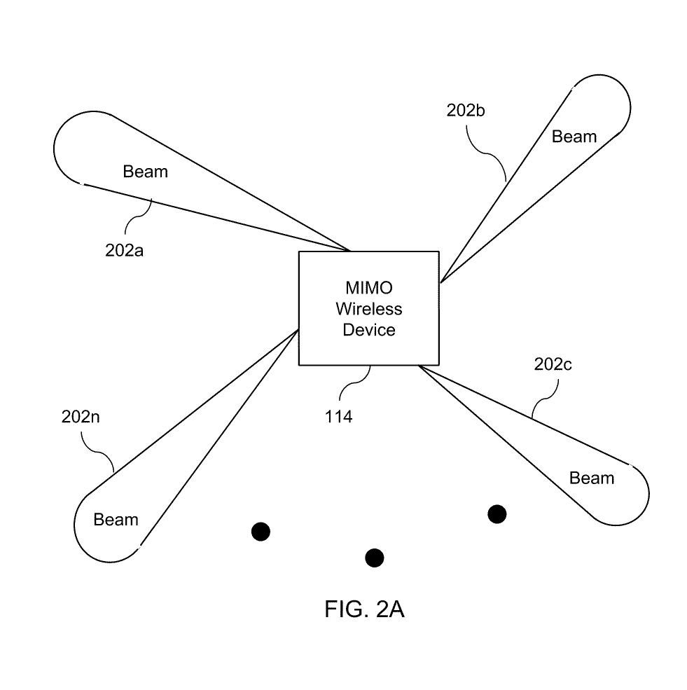

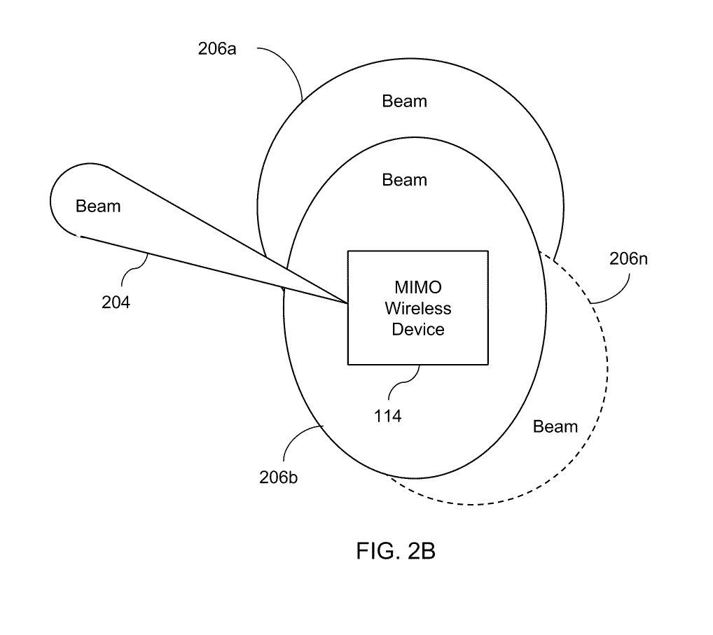

FIG. 2A and 2B illustrate exemplary beams in antenna systems of wireless device 114. As shown, the beams are generated by antennas in wireless device 114 by using a combination of omni-directional and directive antennas. The use of such a combination enables mitigation of the effects of fading, multi-path and reducing undesired interferences in RF link 110. As shown with reference to FIG. 2A, wireless device 114 may use directive antenna array for achieving a pre-scanned performance level. The directive antenna arrays can automatically position in three dimensions (3D) and generate directional beams 202a-n for each RF link 110 from wireless device 114.

As shown with reference to FIG. 2B, one directive antenna generates a beam 204 and beams 206a-n may be generated by Omni-directional antennas. Such a configuration provides a cost effective solution to increase an N×M MIMO RF link performance, where N is the number of the receiving inputs and M is the number of the transmission outputs. In an embodiment of the invention, N is more than or equal to M. Beam 204 may be oriented discretely in one dimension (1D) (Azimuth) while beams 206a-n can be rotated. In an embodiment of the invention, beams 206a-n can be stationary. In an exemplary embodiment, for a wireless MIMO N×M system, the number of the directional antennas may be from 1 to N, and the number of the Omni-directional antennas may accordingly be from N-1 to 0. Since in this configuration, there is a minimal correlation between beam 204 and beams 206a-n, the performance of RF link can be significantly high. Further, beam 204 gets a single transition and most likely provides a desired Signal to Noise Ratio (SNR) of the receiving signal while presenting a high passive gain.

In an embodiment of the invention, the directional antennas may be steered to be positioned in different azimuths, elevations and/or polarization. Therefore, each directional antenna may be directed to a different uncorrelated position for receiving and/or transmitting the signal.

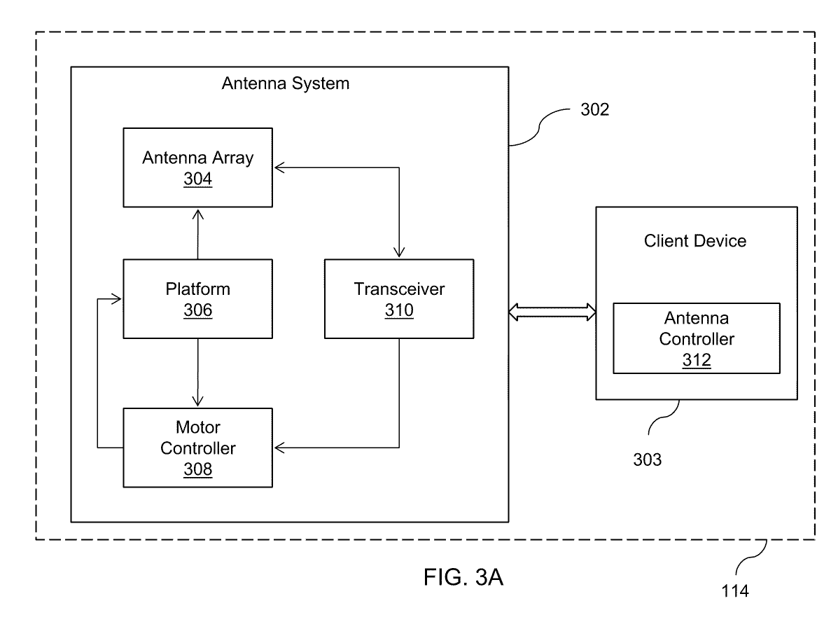

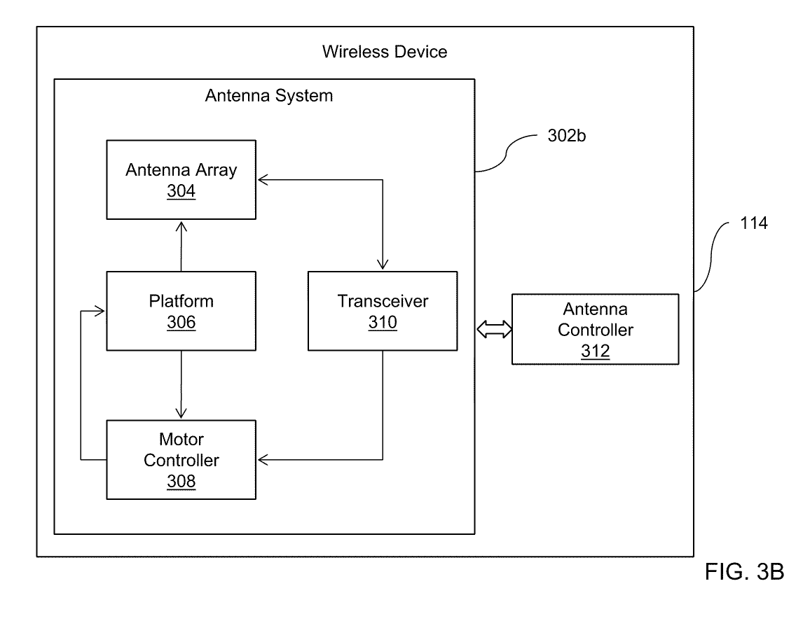

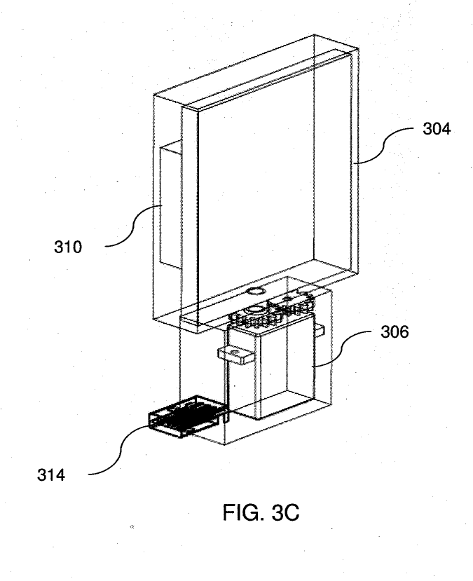

FIG. 3A illustrates a block diagram of an antenna system 302 externally connected to client device 303, in accordance with an embodiment of the invention. Antenna system 302 may be connected to a client device 303. For example, antenna system 302 may be connected to a client device 303 through various wired or wireless data interfaces, such as but not limited to, Universal Serial Bus (USB), Ethernet, Bluetooth, Wi-Fi, Wireless USB (WUSB), other serial or wireless interfaces and so forth. Further, antenna system 302 may be controlled by an antenna controller 312 of client device 303. Client device 303 represents a device that doesn't include or doesn't use it's embedded transceiver 310 and antenna array 304. Client device 303 that is connected to an antenna system 302 are being referred as a wireless device 114. Examples of client device 303 include, but are not limited to, a desktop computer, a laptop, a Personal Desktop Assistant (PDA), a mobile phone, a game, a television or any other client computing device.

Antenna system 302 includes an antenna array 304, a platform 306, a motor controller 308 and a transceiver 310. Antenna array 304 may include multiple directional antennas and/or Omni-directional antennas. Examples of antenna array 304 include, but are not limited to, patch antennas, micro-strip antennas, monopole antennas, dipole antennas, Planar Inverted F Antenna (PIFA), and so forth. Further, antenna array 304 can be implemented on a surface that can be rotated and/or steered. Antenna array 304 can receives and transmits RF signals.

Platform 306 can rotate and position antenna array 304. Platform 306 may include mechanical system such as motor and gears. In an embodiment of the invention, multiple motors may be used for rotating platform 306. Platform 306 can rotate and steer antenna array 304, at any desired angle from 0 to 360 degrees in controlled steps by inputs from motor controller 308. Platform 306 can rotate antenna array 304 within one dimension, two dimensions, three dimensions, or any combination of these. For example, platform 306 can pan (up to about 360 degrees), tilt (up to about 180 degrees), and polarization (such as horizontally, vertically, or circular). Motor controller 308 may include a stepper control, a Direct Current (DC) motor control or other type of motion control circuitry. Motor controller 308 may receive signals for the desired position of platform 306 and translates signals to rotate platform 306 to the desired position. The signals for positioning platform 306 may be received from antenna controller 312.

Transceiver 310 may include wireless standard receiver, transmitter, and baseband processor. Examples of wireless standard include WiFi, WiMax, cellular, LTE and others. Transceiver 310 can converts the RF signals to a data stream while receiving the signals. Further, transceiver 310 can convert the data stream to RF signal for transmitting them. Transceiver 310 receives and decodes RF signals and generates data related to the detected networks and network nodes (for example, routers, BS, clients, and so forth). Further, transceiver 310 transmits parameters for each MIMO channel (RF link) such as RF signal strength, channel bandwidth, and so forth to the antenna controller 312 of wireless device 114. In an embodiment of the invention, transceiver 310 may receive signals from antenna controller 312 for positioning antenna array 304. Signals from transceiver 310 to/from antenna array 304 may be routed through, for example, coax cables, impedance controlled Printed Circuit Board (PCB) routing, and so forth.

Antenna controller 312 may be implemented as hardware, software, firmware or a combination of these. In an embodiment of the invention, antenna controller 312 may be implemented as a processor that can execute programmed instructions or a control algorithm. Further, the parameters received from transceiver 310 may be stored in a database for calculating a desired position for antenna array 304. Antenna controller 312 controls the position of antenna array 304 till the desired position of antenna array 302 is achieved. In an embodiment of the invention, the desired position may correspond to a pre-scanned performance level of RF link 110. Therefore, position of antenna array 304 is controlled in a closed loop. In an embodiment of the invention, antenna controller 312 can detect positional, orientation or location changes of the antenna system 302 and/or wireless device 114 that may contain antenna system 302. Therefore, antenna controller 304 may position antenna array 304 may to correct the detected changes and compensate for a loss and/or degradation of the parameters of RF link 110.

Wireless device 114 may operate in two modes for positioning antenna array 304: an automatic selection of a predefined channel and manual selection. In case of manual selection a user of wireless device 114 may be presented with the networks (and their parameters) that are available. Thereafter, the user can select a preferred network or channel. Subsequently, antenna controller 312 may rotate antenna array 304 to a desired position. Further, wireless device 114 may interface with antenna system 302 in a configuration such as, but not limited to, a Multiple-Input Multiple-Output (MIMO), a Single-Input Multiple-Output (SIMO), a Single-Input Single-Output (SISO), a CO-Multiple-Input Multiple-Output (CO-MIMO), a Net-MIMO, an ad-hoc MIMO, a multi-user MIMO, or a combination thereof.

FIG. 3B illustrates a block diagram of antenna system 302 embedded in a standalone wireless device 114, in accordance with an embodiment of the invention. In this case, antenna system 302 is embedded and self controlled in standalone wireless device 114. The functioning of various components of antenna system 302 may be similar to that discussed with reference to FIG. 3A.

FIG. 3C illustrates antenna system 302 implemented as a dongle, in accordance with an embodiment of the invention. In an embodiment of the invention, the dongle can be a USB dongle. The USB dongle can be connected to a client device 303 such as client device 303, with a USB interface 314 for connecting client device 303 to a wireless network, such as a broadband wireless network. Antenna controller 312 may be implemented on device 303 and communicates with motor controller 308 implemented in antenna system 302 through USB interface 314.

Platform 306 can rotate and steer antenna array 304 to a desired position. In an embodiment of the invention, antenna array 304 is based on a micro strip PCB. Further, the electronic circuitry for motor controller 308 and transceiver 310 can be implemented on a PCB located on a back side of antenna array 304. In another embodiment of the invention, antenna array 304 may be sealed in a silo or may be inside a packaging of wireless device 114. Therefore, the rotation of antenna array 304 may not be visible to the user.

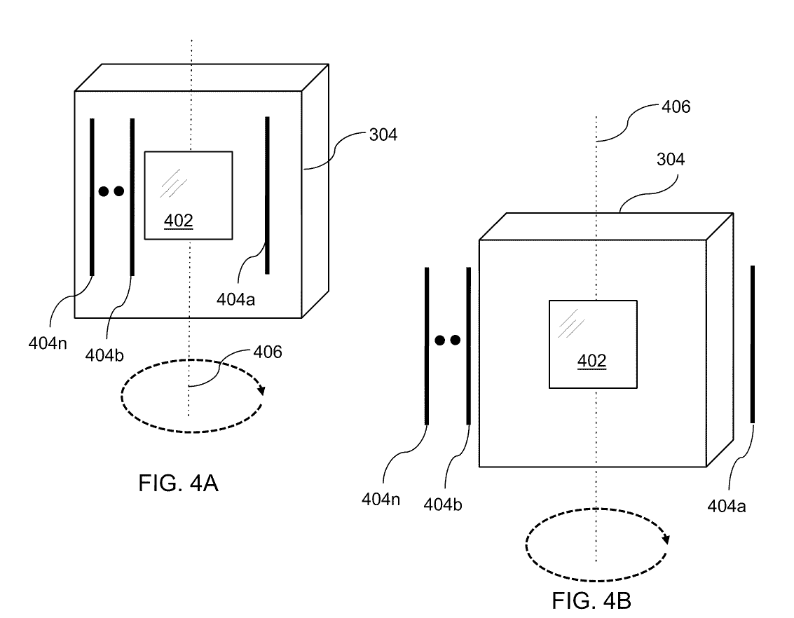

FIGS. 4A and 4B illustrate exemplary arrangements of antenna array 304, in accordance with an embodiment of the invention. As shown in FIG. 4A, antenna array 304 may include a directional antenna 402 and omni-directional antennas 404a-n. Examples of directional antenna 402 include a patch antenna, a micro strip antenna and so forth. Example of omni-directional antennas 404a-n includes dipoles, monopoles and so forth. As shown in FIG. 4A, directional antenna 402 and omni-directional antennas 404a-n can rotate about an axis 406. The angle of rotation may be in a range of 0 degrees to 360 degrees. With reference to FIG. 4B, directional antenna 402 can rotate about axis 406, however omni-directional antennas 404a-n are stationary. The angle of rotation may be in a range of 0 degrees to 360 degrees.

In an embodiment of the invention, antenna array 304 may be implemented as a patch antenna with two PCB having air or high dielectric material between them. In another embodiment of the invention, antenna array 304 may be implemented as a combination of a patch directional antenna 402 and omni-directional antennas 404a-n on the same PCB. Further, antenna array 304 may be the implemented with 2 to N number of omni-directional antennas 404a-n that rotate on one or more axes, where N is the number of the MIMO channels. Therefore, the beam pattern of antenna array 304 can be changed dynamically.

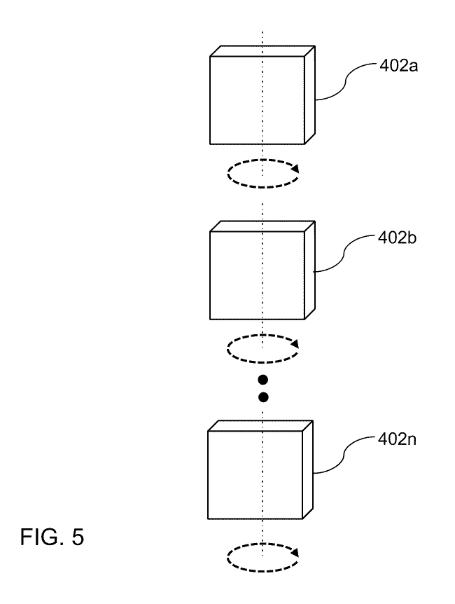

FIG. 5 illustrates arrangement of multiple directional antennas 402a-n, in accordance with an embodiment of the invention. In an embodiment of the invention, directional antennas 402a-n can each be on separate axes. Further, directional antennas 402a-n can be lined on the same vertical or horizontal axis, so that each of directional antennas 402a-n can be directed to different directions and create uncorrelated beams. In another embodiment of the invention, each of directional antennas 402a-n may be positioned in a different direction such that there is no correlation between the beams. Directional antennas 402a-n can be rotated by using multiple motors. In an embodiment of the invention, directional antennas 402a-n can be rotated by using one motor and switched gears. In these cases, antenna system 302 can control each of directional antennas 402a-n to a desired position. Further, the positions may be different between directional antennas 402a-n.

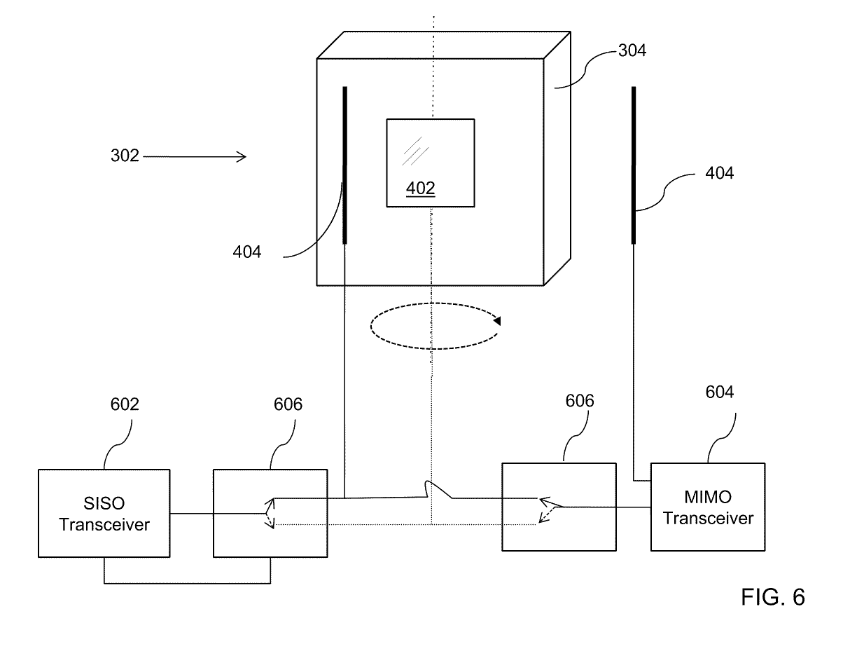

FIG. 6 illustrates an exemplary switched antenna system 302, in accordance with an embodiment of the invention. As shown, antenna system 302 may include antenna array 304 with a directional antenna 402 and an omni-directional antenna 404. Further, antenna array 304 can be rotated about an axis to position it as desired. A MIMO transceiver 604 can be a 2×2 MIMO transceiver. Therefore, MIMO transceiver 604 has two MIMO channels. When such antenna system 302 that include diversity RF switch 606, the RF diversity switch selects substantially the best performance MIMO antenna and therefore may select the best between directional antenna 402 and omni-directional antenna 404. In cases that two directional antennas 402 are connected to RF diversity switch 606, the RF diversity switch select the best between two different directional antennas 402. Further, antennas 702a and 702b may each cover different frequency bands and/or have different positions.

In cases, such as in 3 G, Single Input Single Output (SISO) systems a full 360 degrees cover may be required. Therefore, antenna system 302 can switch between high gain directional antenna 402 and omni-directional antenna 404. A SISO transceiver 602 includes one antenna connection. Therefore, an RF switch 606 may be used to switch between directional antenna 402 and omni-directional antenna 404. Further, SISO transceiver 602 can be used in a case of SISO wireless system such as 3 G, Code Division Multiple Access (CDMA), Global System for Mobile Communications (GSM) and other systems where the use of high gain directional antennas increases range and throughput of the wireless communication link. In case of managed networks such as GSM, CDMA, LTE, WiMax and others, the network may select a BS or AP that a wireless device is to be connected. In such a case, antenna controller 312 may switch between directional antenna 402 and omni-directional antenna 404 to support the managed networks. In an example embodiment, switched antenna system 302 can be utilized for a wireless router. The wireless router may be required to serve wireless devices and create a communication link with them. The wireless router may position or steer antenna array 304 to serve wireless devices and find a position at which the respective reflections can be received and transmitted to achieve a pre-scanned performance level. In an embodiment of the invention, antenna system 302 may select omni-directional antenna 404 and not directional antenna 402, based on the location of the wireless router and the wireless devices. As a result, the overall quality of service may be increased than that of the combination of omni-directional antenna 404 and directional antenna 402.

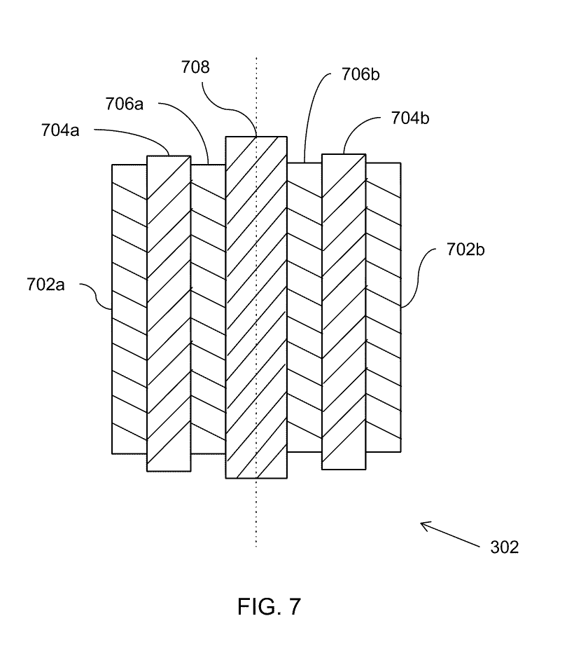

FIG. 7 illustrates antenna array 304 comprising two back to back antennas 702a and 702b, in accordance with an embodiment of the invention. As shown, antennas 702a and 702b may be 180 degrees or 0 to 360 degrees to each other. Further, antennas 702a and 702b may each cover different or same frequency bands. For example, a 3 G antenna may 304 may be required to cover 800 MHz band and 1.9 GHz band. Similarly, Wi-Fi systems may cover 2.4 GHz and 5 GHz frequency bands. Therefore, antenna array 304 includes antennas 702a and 702b to support different frequency bands. Antennas 702a and 702b may be directional antennas. In an embodiment of the invention, antennas 702a and 702b may be a combination of directional and omni-directional antennas. Further, omni-directional antennas may be implemented on one or both sides of antenna array 304. As discussed above, antenna array 302 may be rotated about an axis to cover 360 degrees. Therefore, directional antennas can support the different frequency bands.

As shown, antenna 702a may be implemented on a first side of a PCB 704a. Further, a control system 706a that may include a transceiver, a Network Interface Card (NIC), a motor controller may be implemented on a second side of PCB 704a. In an embodiment of the invention, the second side may be behind a ground plate of PCB 704a. Similarly, antenna 702b, a PCB 704b, and a control system 706b may be implemented. PCB 704a and PCB 704b may be separated by a barrier 708, such as but not limited to, air, a high dielectric material and so forth.

The signal losses can be critical in RF receivers since they define the Noise Figure of antenna system 302. In an embodiment of the invention, antennas 702a and 702b may be connected to the transceivers through short traces. Therefore, signal loss due to cable length between antennas 702a-b and transceivers may be reduced.

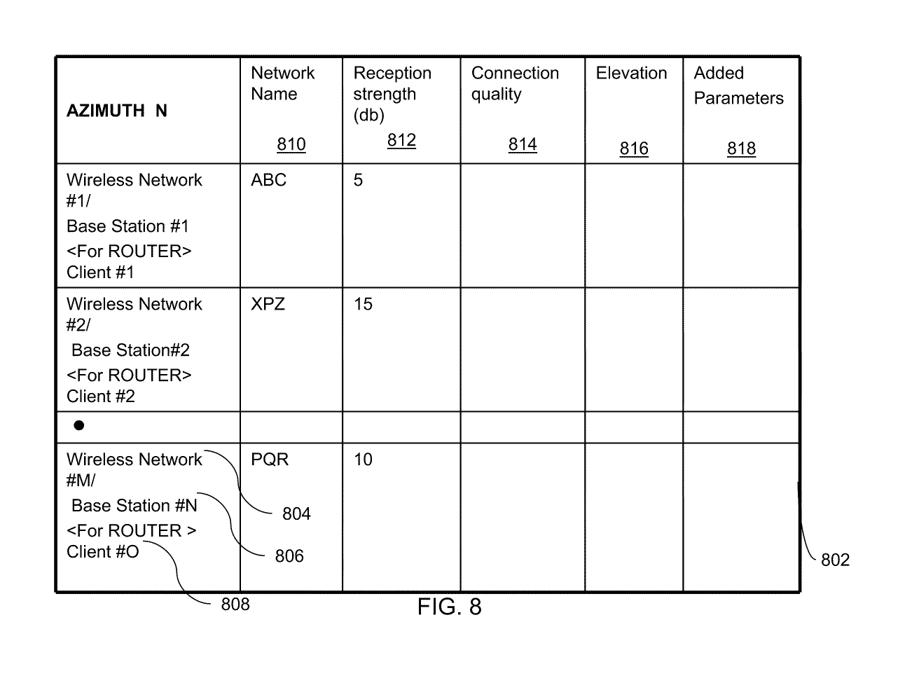

FIG. 8 illustrates an exemplary table 802 that may be generated during a pre-scanning and steering of antenna array 304, in accordance with an embodiment of the invention. Table 802 may be a part of a database that is generated during the pre-scanning and steering of antenna array 304. The database may include N tables where N is the number of steps at which antenna array 304 stopped and scanned the frequency bands while rotating in the range of 0 degrees to 360 degrees. For example, if antenna array 304 rotates in steps of 60 degrees, then N equals 6 and therefore, the database may include 6 tables. Further, the parameters for each table may be generated by transceiver 310. In an embodiment of the invention, the parameters for each table may be generated by a wireless baseband processor of a wireless device. Moreover, all the parameters or columns may not be required. Therefore, some parameters or columns can be omitted or added.

Table 802 may include various entries based on the type of network and wireless devices to be connected. In an embodiment of the invention, separate tables may be generated based on the type of network and wireless devices to be connected. For example, in case of wireless devices that may connect to one or many wireless networks the database contains for each antenna array's azimuth table 802 that includes a wireless network number 804 #M (where M is the number of wireless network found during one full rotation and scanning of antenna array 304), a network name 810 (such as Service Set Identifier (SSID) in case of Wi-Fi network), a reception signal strength 812 (such as RSSI in case of Wi-Fi, WiMax, LTE networks). In an embodiment of the invention, the signal strength may be an aggregate number for all MIMO channels and/or signal strength of each MIMO channels. Signal strength may be provided for example in terms of percentage, ratio and so forth. Table 802 may further include parameters such as, a connection quality 814, an elevation 816 of antenna array 304. Further, table 802 may include added parameters 818, such as but not limited to polarization of antenna array 304.

In another example, in case of wireless devices that may connect to one wireless network but to different base stations, such in WiMax, 3G, LTE, table 802 may include for each azimuth of antenna array 304, a wireless Base Station number 806 #N, where N may be the number of base stations found during one full rotation and scanning of antenna array 304. The rest of table 802 may be as described above.

In another example, in case of a router, an AP, or repeater devices that may connect to multiple clients within one network, table 802 may include for each azimuth of antenna array 304, a client number 808 #O, where O may be the number of wireless devices found during one full rotation and scanning of antenna array 304. The rest of the parameters of wireless devices may be as described above.

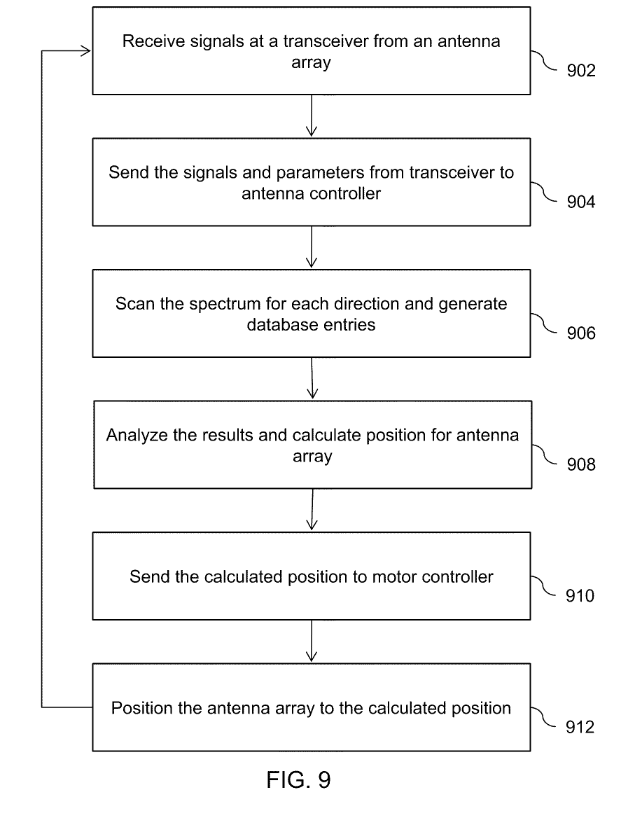

FIG. 9 is flowchart for controlling antenna system 302, in accordance with an embodiment of the invention. At step 902, signals are received at transceiver 310 from antenna array 304. Antenna array 304 may collect RF signals by pre-scanning the frequency bands or the spectrum. In an embodiment of the invention, the pre-scanning may be performed by rotating antenna array 304 in a range of 0 degrees to 360 degrees and scanning each frequency band. Thereafter, at step 904, transceiver 310 may send the parameters such as channel signal strength (RSSI), signal speed (bandwidth) and so forth, to antenna controller 312. In an embodiment of the invention, antenna controller 312 may be implemented as hardware, software or algorithm, or a combination thereof on wireless device 114. At step 906, antenna controller 312 may generate database entries based on the pre-scanning of the frequency spectrum in each direction of antenna array 304. Further, values for pre-scanned performance levels may be gathered based on the pre-scanning. As discussed above, the database may be created for all networks, BS, wireless devices and so forth. Further, for each network, BS, or wireless devices the database may store the statistics of signal strength, speed and capabilities of the network, BS, and/or wireless devices.

At step 908, the results in the database may be analyzed to select a position for antenna array 304. In an embodiment of the invention, an azimuth may be selected from the database for which the aggregated signal strength is the maximum or has a value that corresponds to a pre-scanned performance level. Thereafter, at step 910, a position corresponding to this azimuth may be sent to motor controller 308.

In another embodiment of the invention, an azimuth may be selected from the database for which the bandwidth and/or the speed of the modem are the maximum or have values that correspond to a pre-scanned performance level. Thereafter, at step 910, a position corresponding to this azimuth may be sent to motor controller 308.

In yet another embodiment of the invention, an azimuth may be selected from the database for which the combination of signal strength and bandwidth and/or speed of the modem are the maximum or have values that correspond to a pre-scanned performance level. Thereafter, at step 910, a position corresponding to this azimuth may be sent to motor controller 308.

In case of a router, a repeater, or an AP, there may be a selected wireless device that requires maximum or a predefined value of bandwidth and has priority over other wireless devices, for example in high bandwidth wireless gateway. In such a case, azimuth may be selected from the database at which the signal strength and/or modem bandwidth for the selected wireless device are maximum or have values that correspond to a pre-scanned performance level. Thereafter, at step 910, a position corresponding to this azimuth may be sent to motor controller 308.

Further, in case of a router, a repeater, or an AP, there may be one or more wireless devices that are preselected to have priority of service. Therefore, the preselected wireless devices may require a maximum or a predefined value of bandwidth, and have priority above the any other wireless devices. In such a case, azimuth may be calculated from the database at which the signal strength and/or modem bandwidth for all preselected wireless devices are maximum or have values that correspond to a pre-scanned performance level. Thereafter, at step 910, a position corresponding to this azimuth may be sent to motor controller 308.

Further, in case of a router, a repeater, or an AP, all wireless devices may have same priority of service. Therefore, all wireless devices may require maximum or a predefined bandwidth. In such a case, azimuth may be calculated from the database at which the signal strength and/or modem bandwidth for all clients are maximum or have predefined values. Thereafter, at step 910, a position corresponding to this azimuth may be sent to motor controller 308.

Subsequently, at step 912, motor controller 308 may position antenna array 304 based on the position value received from antenna controller 312. In an embodiment of the invention, one or more of the above mentioned steps may be repeated to achieve a pre-scanned performance level of the communication link. Moreover, the method as discussed may require synchronization between the positioning phases and the communication link connection states. For example, in case of Wi-Fi the initial state is a “no connection”. Therefore, a station may search for a position based on beacons transmission of the router, repeater, or AP. Thereafter, antenna system 302 may select a position by running local search. The local search can be performed, for example by searching in small rotation steps such as 3, 5, 10 degrees, and so forth, in a limited range, such as 15-90 degrees, and so forth.

In an embodiment of the invention, antenna system 302 operates with a higher directive passive gain antenna. Therefore, antenna system 302 can reduce transmission power, and thus the overall power consumption of antenna system 302 and wireless device 114 may be reduced. Moreover, transmit power may be reduced based on achieving a preset default or a pre-scanned performance of the RF link such as: signal strength and throughput. In an embodiment of the invention, the default values may be set by the user of wireless device 114.

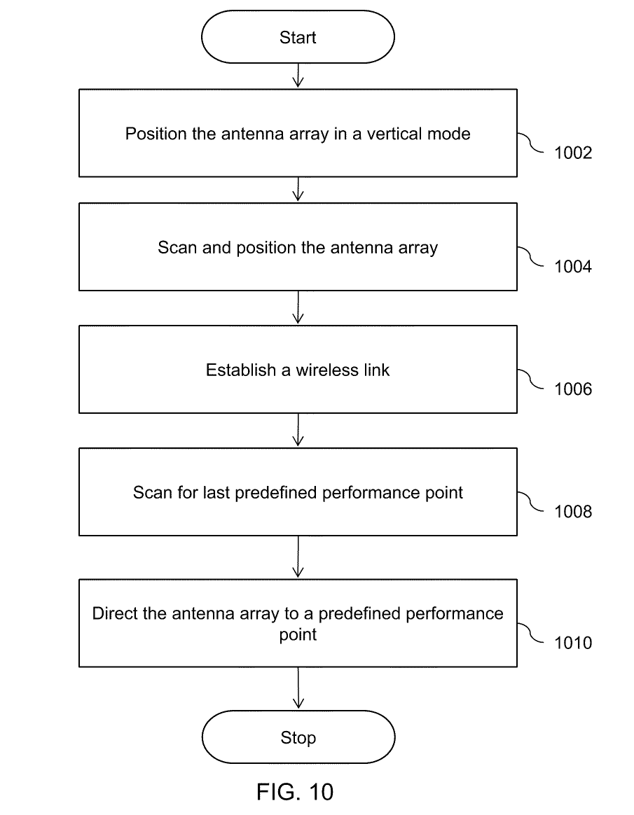

FIG. 10 is a flowchart for scanning in one dimension (1D), in accordance with an embodiment of the invention. Scanning in 1D includes scanning towards a maximum or a pre-scanned performance point by controlling an azimuth of antenna array 304. In an embodiment of the invention, scanning may be performed by controlling an elevation of the antenna array 304. At step 1002, antenna array 304 may be positioned in a vertical mode, for example parallel to the earth or ground. Thereafter, at step 1004, —scanning is performed in a range of 0 degrees to 360 degree in predefined degrees steps. For example, the predefined degree steps may be 15 degrees. In an embodiment of the invention, the scanning may be performed for different values in azimuth axis. Thereafter, antenna array 304 may be positioned based on a pre-scanned performance point. For example, the pre-scanned performance point may be the maximum value of parameters such as, but not limited to, RSSI, speed for each one or all combinations of the MIMO channels, and so forth.

At step 1006, a wireless link may be established. The wireless link may support and optimize the use of beam forming. At step 1008, scanning may be performed around a previous pre-scanned performance point. For example, the scanning may be performed for ±X degrees (for example, 30 degrees) in steps of Y degrees, where Y can be value as the last scan step or reduced by a Z%, for example 20%. In an embodiment of the invention, the previous pre-scanned performance point can be the maximum performance point at which the maximum performance of the wireless link can be achieved. The scanning at step 1008 may be repeated for predefined number of repetitions to select the previous pre-scanned performance point. Subsequently, at step 1010, antenna array 304 may be directed to a calculated position to achieve a pre-scanned performance level. In an embodiment of the invention, steps 1006, 1008, and 1010 may be optional and may not always be performed. In an embodiment of the invention, the scanning as discussed above may be performed after the pre-scanning process for gathering parameters and pre-scanned performance level.

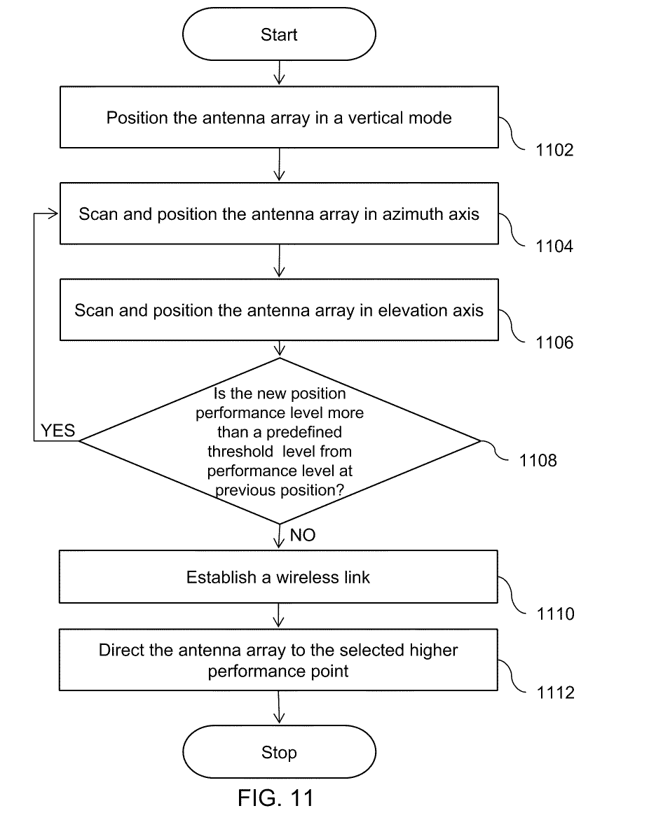

FIG. 11 is a flowchart for linear scanning in two dimensions (2D), in accordance with an embodiment of the invention. Scanning in 2D includes scanning towards a maximum or a pre-scanned performance point by controlling an azimuth and an elevation of antenna array 304 combined or separately. At step 1102, antenna array 304 may be positioned in a vertical mode, for example parallel to earth ground. The position coordinates can be for example, azimuth axis position at 0 degree, X=0, and elevation Y=0. Position of X and Y can be represented by P, where P=(0, 0) at X=0 and Y=0.

At step 1104, scanning is performed in a range of 0 degrees to 180 degree in predefined degrees steps. For example, the predefined degree steps may be 15 degrees in azimuth axis. Subsequently, position antenna array 304 at a point P such that a pre-scanned performance level is achieved. For example, the pre-scanned performance level may be achieved at a maximum RSSI and speed.

At step 1106, scanning is performed in predefined degree steps. For example, the predefined degree steps may be ±10 degrees in elevation axis around point P detected in step 1104. Subsequently, antenna array 304 may be positioned at a new point P by performing the steps 1106 and 1104. Thereafter, at step 1108, the new performance level at the new position point P may be checked to ascertain whether it is more than the performance level at the previous position point P by a predefined threshold level. If the condition at step 1108 is false, then the steps 1104 and 1106 may be repeated. Otherwise, if the condition at step 1108 is true, then the process continues to step 1108. For example, the pre-scanned performance level may be achieved at a maximum RSSI and speed In an embodiment of the invention, the predefined threshold level may be defined by antenna controller 312.

At step 1108, a wireless link may be established. The wireless link may support and optimize the use of beam forming. At step 1108, scanning may be performed around the point P. For example, the scanning may be performed for ±X degrees (for example, 15 degrees) in steps of Y degrees, where Y can be value as the last scan step or reduced by a Z%, for example 20%. Further, the scanning at step 1104 and 1106 may be repeated for predefined number of repetitions to select the point P. Subsequently, at step 1010, antenna array 304 may be directed to the point P. In an embodiment of the invention, step 1108 may be optional and may not always be performed. In an embodiment of the invention, the scanning as discussed above may be performed after the pre-scanning process for gathering parameters and pre-scanned performance level.

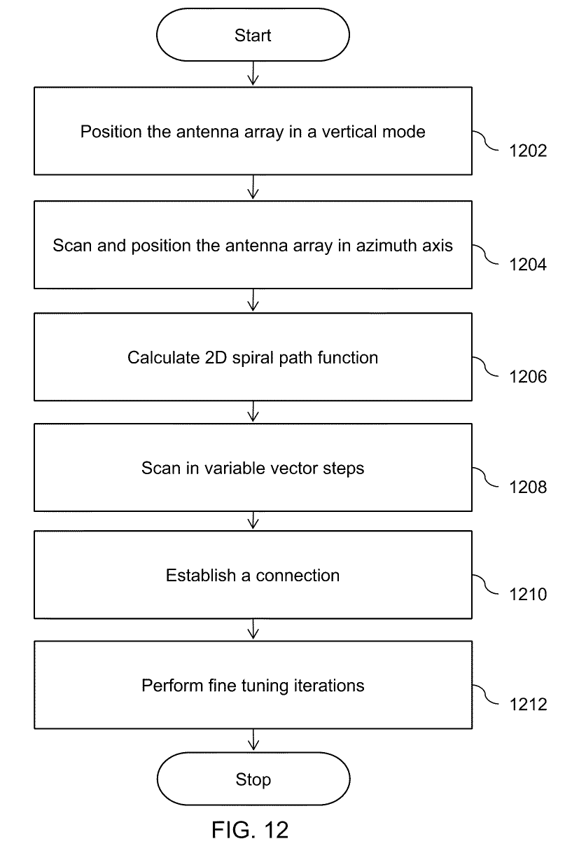

FIG. 12 is a flowchart for spiral scanning in two dimensions (2D), in accordance with an embodiment of the invention. At step 1202, antenna array 304 may be positioned in a vertical mode, for example parallel to earth ground. The position coordinates can be for example, azimuth axis position at 0 degree, X=0, and elevation Y=0. Position of X and Y can be represented by P, where P=(0, 0) at X=0 and Y=0.

At step 1204, scanning is performed in a range of 0 degrees to 180 degree in predefined degrees steps. For example, the predefined degree steps may be 15 degrees in azimuth axis. Subsequently, position antenna array 304 at a point P such that a pre-scanned performance level is achieved. For example, the pre-scanned performance level may be achieved at a maximum RSSI and speed.

Thereafter, at step 1206 calculate and create a 2D spiral path function based on the point P. At step 1208, scanning may be performed in variable vector steps. For example, the scanning may start with a vector on the azimuth and the elevation axes, thereafter vector step's size may be decreased in a logarithmic or a linear method. For every point in the scan path, a gradient towards the pre-scanned performance point may be calculated and the direction of the spiral path may be updated. In an embodiment of the invention, the pre-scanned performance point may be calculated based on RSSI, speed, SNR, and/or any other parameter at the points in the spiral path.

At step 1210, a connection is established, for example a Wi-Fi client may connects to a Wi-Fi AP/router. Subsequently, at step 1212, antenna controller 312 may perform fine tuning iterations either in 1D or 2D and position antenna array 304 based on the calculations. In an embodiment of the invention, the step 1212 is optional and therefore may not always be performed. In an embodiment of the invention, the scanning as discussed above may be performed after the pre-scanning process for gathering parameters and pre-scanned performance level.

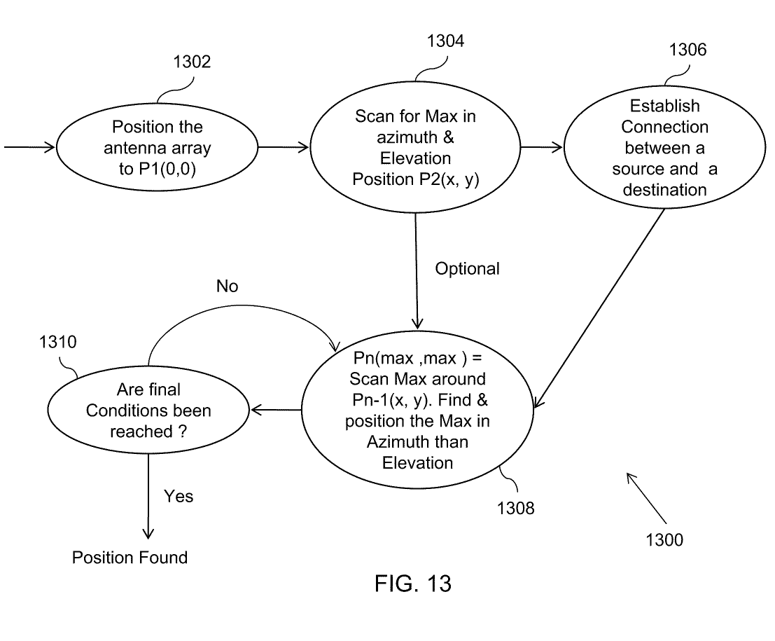

FIG. 13 illustrates a state machine diagram 1300 corresponding to an algorithm performed at antenna controller 312, in accordance with an embodiment of the invention. State machine diagram 1300 includes positioning with 1D or 2D, linear or spiral iterations methods for MIMO communication systems, such as but not limited to, Wi-Fi, WiMax, and LTE. In case only azimuth control exists in antenna system 302, then in state machine 1300, scanning may be performed only for azimuth.

At state 1 1302: a position may be set for antenna array 304 to P (0, 0) (X=0, Y=0) horizontally for azimuth scanning or vertically for elevation scanning.

At state 2 1304: scan for a predefined or maximum link performances without establishing a connection (for example based on beacons) and without beam forming.

At state 3 1306: establish a connection (for example, connection of a client with a router, an AP, a BS, or connection of a station to a station). Further, methods such as beam forming may be activated if available in antenna system 302.

At state 4 1308: scan again in a method that may leverage and use the methods such as beam forming, for example, analyzing each MIMO channel and aggregate performances such as RSSI, speed, throughput, Carrier to Interference-plus-Noise Ratio (CINR), Signal to Interference-plus-Noise Ratio (SINR), Bit Error Rate (BER). In an embodiment of the invention, state 4 1308 may be optional and therefore, may not always be performed.

At state 5 1310: check whether a predefined or a maximum performance position was found, based on different parameters such as, but not limited to, iteration step size, the antenna array beam pattern, improvement prediction, number max iterations and so forth. In case, the predefined or a maximum performance position was not found then state machine 1300 returns to state 4 1308.

In an embodiment of the invention, a subset of the above states can be implemented. For example, state 1 1302 and state 2 1304; state 1 1302, state 2 1304, and state 3 1306; state 1 1302, state 2 1304, state 1308, and so forth.

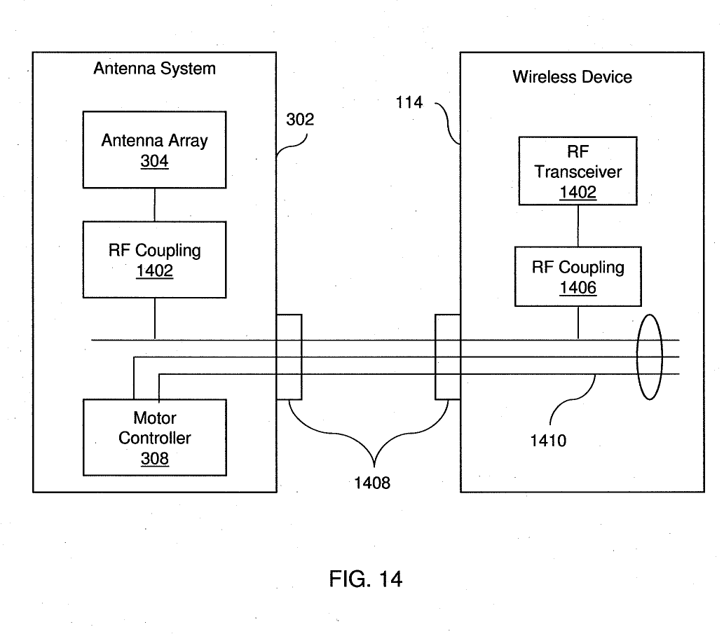

FIG. 14 illustrates a block diagram for connecting antenna system 302 to wireless device 114 that may not have an external RF connector, in an embodiment of the invention. In an embodiment of the invention, wireless device 114 includes an embedded wireless transceiver 1404. Antenna system 302 may be a high gain antenna. In an embodiment of the invention, antenna system 302 may be a smart antenna system 302 that can be connected to antenna inputs of an internal RF transceiver 1404 of wireless device 114. Wireless devices that include external antenna or RF connectors may not need such a connection

In an embodiment of the invention, wireless device 114 includes a data, sound, and a video interface connection, such as USB port 1408. Further, wireless device 114 may not have an external RF connector such as subminiature version A (SMA). In this case, RF signals can be coupled into one of the power, data signals via a RF coupling 1402 circuitry. RF coupling 1402 circuitry may include elements such as, but not limited to, capacitors, resistors, coils and so forth, in a manner such that the circuit may not interfere with the power or data. Moreover, RF coupling 1402 circuitry may be design such that it enables keeping the impedance matching on antenna system 302 and wireless device 114. Further, as shown, motor controller 308 of antenna system 302 may be connected through USB interface 1408.

The connection as described may be used with simple antennas like dipole or others to extend the internal antenna externally in a wireless device or system that may not have an external antenna connection. Further, the connection as discussed may provide extra gain and may eliminate internal interferences and noises in wireless device 114, which can enhance the capabilities of embedded wireless devices.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An antenna system for connecting to one or more wireless devices through one or more wireless communication links, the antenna system comprising:
an antenna array configured to pre-scan one or more frequency bands of radio signals in a plurality of antenna positions;
a transceiver connected to the antenna array, wherein the transceiver is configured to:
analyze the radio signals received from the antenna array to obtain one or more parameters from one or more MIMO channels of said antenna array; and
transmit the one or more parameters to the client devices through data interface;
a platform connected to the antenna array, wherein the platform is configured to position the antenna array; and
a motor controller connected to the platform, wherein the motor controller is configured to:
receive one or more position signals from the client device, wherein the position signals correspond to a pre-scanned performance level of the wireless communication links between the antenna system and the one or more wireless devices, said performance level is based on the one or more parameters; and
control a position of the antenna array by rotating the platform based on the position signals.

2. The antenna system of claim 1, wherein the antenna array comprises a plurality of directional antennas.

3. The antenna system of claim 2, wherein the plurality of directional antennas cover different frequency bands.

4. The antenna system of claim 2, wherein the directional antennas are aligned at an angle of between 0 and 360 degrees to each other.

5. The antenna system of claim 1, wherein the antenna array comprises at least one omni-directional antenna.

6. The antenna system of claim 1, wherein the antenna array operates according to at least one of a Wi-Fi, a 3G, a Long Term Evolution (LTE), or a WiMax standard.

7. The antenna system of claim 1, wherein the antenna system is configured to interface with at least one topology of a Multiple-Input Multiple-Output (MIMO), a Single-Input Multiple-Output (SIMO), a Single-Input Single-Output (SISO), a CO-Multiple-Input Multiple-Output (CO-MIMO), a Net-MIMO, an ad-hoc MIMO, a multi-user MIMO, or a combination thereof.

8. The antenna system of claim 1, wherein the motor controller is further configured to move the antenna array according to one of a linear path or a spiral path towards the position corresponding to the pre-scanned performance level.

9. The antenna system of claim 1, wherein the one or more parameters from one or more MIMO channels include at least one of a Received Signal Strength Indicator (RSSI), a Signal to Noise Ratio (SNR), a Carrier to Interference Noise Ratio (CINR), a speed, a throughput, a Service Set Identifier (SSID), or a combination thereof.

10. The antenna system of claim 1,
wherein the client device comprises an antenna controller configured to calculate a position of the antenna array based on the one or more parameters from one or more MIMO channels,
wherein the position of the antenna array has a corresponding a pre-scanned performance level of the wireless communication link.

11. The antenna system of claim 1, wherein the antenna system is connected through data interface to the client device through at least one of a Universal Serial Bus (USB) interface, an Ethernet interface, Bluetooth, Wi-Fi, or Wireless USB.

12. The antenna system of claim 1, wherein the pre-scanned performance level is selected based on at least one of signal strength, a bandwidth, a speed, or a priority of service of one or more wireless devices to be connected to the antenna system.

13. A wireless device, comprising:
an antenna controller configured to analyze one or more parameters of radio signals, wherein the antenna controller selects a pre-scanned performance level based on one or more parameters from one or more MIMO channels of a communication link;
an antenna array configured to scan one or more frequency bands of radio signals in a plurality of antenna positions;
a transceiver connected to the antenna array, wherein the transceiver is configured to:
analyze the signals received from the antenna array for the one or more parameters; and
transmit the one or more parameters to the antenna controller;
a platform connected to the antenna array, wherein the platform is configured to position the antenna array; and
a motor controller connected to the platform, wherein the motor controller is configured to:
receive one or more position signals from the antenna controller, wherein the position signals correspond to a pre-scanned performance level of the communication link based on the one or more parameters; and
control a position of the antenna array by rotating the platform based on the position signals.

14. The wireless device of claim 13, wherein the antenna array comprises a plurality of directional antennas.

15. The wireless device of claim 14, wherein directional antennas cover different frequency bands.

16. The wireless device of claim 14, wherein the directional antennas are aligned at an angle of between 0 and 360 degrees to each other.

17. The wireless device of claim 13, wherein the antenna array comprises at least one omni-directional antenna.

18. The wireless device of claim 13, wherein the motor controller moves the antenna array according to one of a linear path or a spiral path towards the position corresponding to a pre-scanned performance level.

19. The wireless device of claim 13, wherein the antenna controller is further configured to position the antenna array based on a change in at least one of a direction, position, or orientation of the wireless communication device.

20. A method for positioning an antenna array to be connected to a wireless device through a wireless link, comprising:
pre-scanning for one or more radio signals by an antenna array in a plurality of antenna positions;
analyzing, by a transceiver, the signals received from the antenna array to obtain one or more parameters from one or more MIMO channels of said antenna array;
transmitting, by the transceiver, the one or more parameters to the antenna controller, wherein a pre-scanned performance level may be selected based on the one or more parameters;
receiving, by the motor controller, one or more position signals from the antenna controller for controlling a position of the antenna array, wherein the position of the antenna array corresponds to the pre-scanned performance level of the wireless communication link; and
positioning the antenna array by the motor controller based on the one or more position signals.

21. The method of claim 20, further comprising analyzing the one or more parameters from one or more MIMO channels by an antenna controller to generate information encoding the position of the antenna array.

22. The method of claim 20, wherein the scanning is performed according to one of a linear path or a spiral path towards the position corresponding to a pre-scanned performance level.
